(19) United States
(12) Patent Application Publication
(10) Pub. No.: US 2019/0205712 A1
(43) Pub. Date: Jul. 4, 2019

(54) FLEXIBLE UHF RFID ANTI-METAL TAG

(71) Applicant: Army Armored Academy, Beijing (CN)

(72) Inventors: Lihong Dong, Beijing (CN); Haidou Wang, Beijing (CN); Miao Zhang, Beijing (CN)

(21) Appl. No.: 16/296,252

(22) Filed: Mar. 8, 2019

(30) Foreign Application Priority Data
Jul. 27, 2018 (CN) 2018108441848

(51) Int. Cl. G06K 19/02; G06K 19/077

(52) U.S. Cl. CPC G06K 19/025; G06K 19/07773; G06K 19/0776

(57) ABSTRACT

Embodiments of the present disclosure provide a flexible UHF RFID anti-metal tag including a tag chip, an antenna layer, a substrate layer and a metal base layer sequentially attached from top to bottom. The substrate layer includes a first and a second dielectric layer being sequentially attached from top to bottom. The first dielectric layer is attached to the antenna layer, and the second dielectric layer is attached to the metal base layer. A metal member to be labeled and the metal base layer jointly eliminate the interference of the metal on an equivalent circuit of the antenna. The substrate layer uses a polymer material as the first dielectric layer, and a support flexible material with the lower cost, such as the foam dielectric layer, is used as the second dielectric layer, which saves cost while ensuring sufficient flexibility of the substrate layer.

### TECHNICAL FIELD

The presently disclosed subject matter generally relates to the field of radio frequency identification (RFID) sensing. Particularly, the present subject matter relates to a flexible ultra high frequency (UHF) RFID anti-metal tag.

### BACKGROUND

In recent years, radio frequency identification (RFID) has been widely favored in the manufacturing, logistics, and inspection fields due to its wireless and passive characteristics. Currently, product tracking in production and logistics has been realized. Among them, the electronic tag in the RFID system is mainly composed of an antenna layer, a dielectric base layer and a protective layer. Among them, as the structure of the object to be identified becomes more and more complicated and miniaturized, the demand for the tag attached to the product increases. The biggest problem in the use of electronic tag in prior art is that attaching the antenna layer and the chip member to the rigid dielectric layer causes the tag to have no bending function, which may not meet the requirements for installation in case of bending and large curvature, such as the case of metal tube, a human or animal body, and the like, thereby restricting the development of the electronic tag.

At the same time, since the tag is on different materials, its performance will fluctuate greatly. Especially for the most widely used metal environment, many solutions have been proposed recently, such as folded dipoles, absorbing materials, EBG/AMC structures, and the like. The use of these anti-metal methods, such as special materials and antenna structures, will increase the cost of the tag, which is not conducive to mass production of electronic tags.

In recent years, some concepts and achievements of flexible metal tags have emerged. Although these achievements have improved the traditional tag to some extent, there are still shortcomings such as complicated structure, special material selection and high cost, which is not conducive to mass production of metal tags.

Therefore, there is currently a lack of a flexible UHF RFID anti-metal tag, which has the advantages of simple structure, universal material selection, low cost, and is applicable to metal plates, various surface parts of curved surfaces and round pipe products with no affection by metal materials.

### SUMMARY

In order to solve the above problems, the present disclosure provides a flexible ultra high frequency (UHF) radio frequency identification (RFID) anti-metal tag, including a tag chip, an antenna layer, a substrate layer and a metal base layer sequentially attached from top to bottom.

An embodiment of the present disclosure provides a flexible ultra high frequency (UHF) radio frequency identification (RFID) anti-metal tag, including a tag chip, an antenna layer, a substrate layer and a metal base layer sequentially attached from top to bottom. The substrate layer includes a first dielectric layer and a second dielectric layer, which are sequentially attached from top to bottom. The first dielectric layer is attached to the antenna layer, and the second dielectric layer is attached to the metal base layer, for using the metal base layer to eliminate the interference of the metal member on the performance of the tag, so that the excellent performance of the electronic tag is ensured.

According to an aspect of the present disclosure, the flexible UHF RFID anti-metal tag further includes a protective layer that wraps the tag chip.

According to an aspect of the present disclosure, the protective layer being coated on the antenna layer, the material of the protective layer being an ink.

According to another aspect of the present disclosure, the tag chip and the antenna layer are fixed by using at least one of a wire bonding process and a conductive adhesive.

According to another aspect of the present disclosure, a wire used in the wire bonding process includes a gold wire or an aluminum wire.

According to another aspect of the present disclosure, the conductive adhesive is a thermosetting conductive adhesive.

According to another aspect of the present disclosure, the material of the antenna layer is copper or aluminum.

According to another aspect of the present disclosure, the antenna is composited on the first dielectric layer by an etching process, further wherein a thickness of the antenna layer is in a range of 10-16^{μm}.

According to another aspect of the present disclosure, the first dielectric layer is a polymer film, and the material of the polymer film, wherein a material of the polymer film includes at least one of a polyimide or polyethylene terephthalate.

According to another aspect of the present disclosure, the second dielectric layer includes a foam dielectric layer.

According to another aspect of the present disclosure, the first dielectric layer and the second dielectric layer are bonded by a backing adhesive.

According to another aspect of the present disclosure, a thickness of the first dielectric layer is in a range of 50-125^{μm}, and the second dielectric layer a thickness of the second dielectric layer is in a range of 2-3 mm.

According to another aspect of the present disclosure, a material of the metal base layer includes copper, and the metal base layer has a same outer contour as the antenna layer.

According to another aspect of the present disclosure, the flexible UHF RFID anti-metal tag is bonded to a metal member by a self-adhesive.

Another embodiment of the present disclosure provides a design and verification method for flexible ultra high frequency (UHF) radio frequency identification (RFID) anti-metal tag. The design and verification method includes optimizing and determining a material and an optimal parameter of the flexible UHF RFID anti-metal tag by using an electromagnetic simulation software such as, but not limited to, a high frequency structure simulator (HFSS) or a computer simulation technology (CST), and fabricating the flexible UHF RFID anti-metal tag. The design and verification method further includes connecting a Tagformance reader to the flexible UHF RFID anti-metal tag and collecting a performance parameter of the flexible UHF RFID anti-metal tag until the flexible UHF RFID anti-metal tag reaches an optimal reading distance, and reading an information.

The present disclosure provides a flexible UHF RFID anti-metal tag, which is bonded to the metal member by a self-adhesive, and does not use a special material to shield influence from the metal, but adopts an antenna layer-substrate layer-metal base layer to form a microstrip antenna structure while the metal member acting as an extension of the metal base layer, to eliminate interference of the metal on an equivalent circuit of the antenna, so that information of the flexible UHF RFID anti-metal tag may be read and written normally. The substrate layer uses a polymer material as the first dielectric layer, and a supportive flexible material of lower cost, such as a foam dielectric layer, is used as the second dielectric layer, so as to save cost while ensuring sufficient flexibility of the substrate layer, thereby greatly saving money. The flexible UHF RFID anti-metal tag has the advantages of simple structure, universal material selection, low cost, and is applicable to metal plates, various surface parts of curved surfaces and round pipe products with no affection by metal materials and a wide applicability for production.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1 illustrates a structural view of an exemplary flexible ultra-high frequency (UHF) RFID anti-metal tag, in accordance with an embodiment of the present disclosure.

### DETAILED DESCRIPTION OF THE EMBODIMENTS

The following detailed description is made with reference to the figures. Exemplary embodiments are described to illustrate the disclosure, not to limit its scope, which is defined by the claims. Those of ordinarily skilled in the art will recognize a number of equivalent variations in the description that follows.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

The specific implementation of the invention will be further described in detail in combination with drawings and the embodiment. The following embodiment is used for illustrating the invention but limiting the scope thereof.

In the current market of anti-metal tags, some concepts and achievements of flexible metal tags have emerged. Although these achievements have improved the traditional tag to some extent, there are still shortcomings such as complicated structure, special material selection and high cost, which is not conducive to mass production of metal tags.

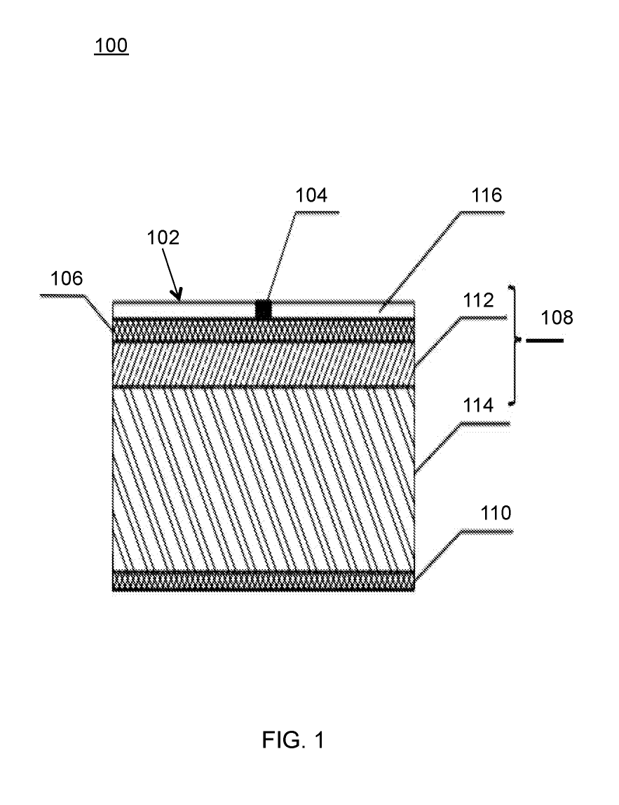

FIG. 1 illustrates a structural view 100 of a flexible ultra high frequency (UHF) radio frequency identification (RFID) anti-metal tag 102 according to a preferred embodiment of the present disclosure. As shown in the FIG. 1, the flexible UHF RFID anti-metal tag 102 includes a tag chip 104, an antenna layer 106, a substrate layer 108 and a metal base layer 110 sequentially attached from top to bottom. The substrate layer 108 includes a first dielectric layer 112 and a second dielectric layer 114 which are sequentially attached from top to bottom. Further, the first dielectric layer 112 is attached to the antenna layer 106, and the second dielectric layer 114 is attached to the metal base layer 110.

In some embodiments, the tag chip 104, the antenna layer 106, the substrate layer 108, and the metal base layer 110 are sequentially attached from top to bottom. The substrate layer 4 is constituted by attaching the first dielectric layer 112 and the second dielectric layer 114 from top to bottom, respectively. The first dielectric layer 112 and the second dielectric layer 114 may be selected according to actual needs, and the thickness ratio may also be matched according to actual needs, so that the flexibility of the substrate layer 108 may ensure the flexibility of the flexible UHF RFID anti-metal tag 102. The metal base layer 110 may eliminate the interference of the metal on the equivalent circuit of the antenna, thereby achieving the normal reading and writing of the flexible UHF RFID anti-metal tag 102.

As shown in FIG. 1, the flexible UHF RFID anti-metal tag 102 further includes a protective layer 116. The protective layer 116 wrapping the tag chip 1. Further, the protective layer 114 is coated on the antenna layer 106, and a material of the protective layer 116 includes an ink.

In some embodiments, the tag chip 104 is attached to the antenna layer 106, and in order to prevent the metal conductor of the antenna from aging, a protective layer 116 is coated on the antenna layer 106. Then, the protective layer 116 wraps the tag chip 104 and protects the antenna layer 106 together with the tag chip 104.

Based on above embodiment, the tag chip 104 and the antenna layer 106 are fixed by a wire bonding process or a conductive adhesive. Further, a wire used in the wire bonding process includes a gold wire or an aluminum wire, and the conductive adhesive includes a thermosetting conductive adhesive.

In some embodiments, a material of the antenna layer 106 includes copper or aluminum, and the antenna is composited on the first dielectric layer 112 by an etching process, the antenna layer 114 having a thickness in a range of 10-16^{μm}.

In some embodiments, the first dielectric layer 112 includes a polymer film, and a material of the polymer film includes polyimide or polyethylene terephthalate. The second dielectric layer 114 includes a foam dielectric layer. Further, the first dielectric layer 112 and the second dielectric layer 114 are bonded by a backing adhesive.

Further, the first dielectric layer 112 has a thickness in a range of 50-125^{μm}, and the second dielectric layer 114 has a thickness in a range of 2-3 mm.

In some embodiments, a material of the metal base layer 5 includes copper, and the metal base layer 110 has a same outer contour as the antenna layer 106.

Based on above embodiment, the flexible UHF RFID anti-metal tag is bonded to a metal member by a self-adhesive.

Another embodiment of the present disclosure provides a design and verification method for the flexible UHF RFID anti-metal tag 102. The method includes optimizing and determining a material and an optimal parameter of the flexible UHF RFID anti-metal tag 102 by using suitable electromagnetic simulation software such as, but not limited to, a high frequency structure simulator (HFSS) or a computer simulation technology (CST). The method also includes fabricating the flexible UHF RFID anti-metal tag 102. The method also includes doing performance testing with a Tagformance test system by placing the flexible UHF RFID anti-metal tag 102 on a foam holder above the antenna layer 106 of the instrument and collecting a performance parameter of the flexible UHF RFID anti-metal tag 102 until the flexible UHF RFID anti-metal tag 102 reaches an optimal reading distance, and reading information.

Below is a non-limiting example to illustrate the design and verification method of the flexible UHF RFID anti-metal tag 102, thereby embodying the achievability of the flexible UHF RFID anti-metal tag 102.

The flexible UHF RFID anti-metal tag 102 used in the present embodiment has a contour size of 90*70*3.08 mm³. The tag chip 104 uses H3 chip from Alien Corporation. A material used for the protective layer 116 is a protective ink, which is coated on the antenna layer 106 to prevent oxidation of the antenna conductor. The antenna conductor used in the antenna layer 106 is copper. The copper is directly composited onto the polyimide film of the first dielectric layer 112, and an etching process is performed, so that a thickness of the conductor is 15 μm. The tag chip 104 and the antenna conductor of the antenna layer 106 are bound together by an aluminum wire and encapsulated with a black plastic. The first dielectric layer 112 of the substrate layer 108 is a polyimide film (PI) of 50 μm having a dielectric constant of 3.5 and a loss tangent angle of 0.08. Meanwhile, a second dielectric layer 114 is made of a foam dielectric layer having a dielectric constant of 1.12 and a thickness of 3 mm is designed below the polyimide film of the first dielectric layer 112. The two dielectric layers are bonded by a back adhesive. A metal base with a material of copper is attached to the back surface of the lower layer of the substrate layer 108, and the structure for entire electronic tag has no via holes or short-circuit wires. The flexible UHF RFID anti-metal tag 102 has a working frequency range of 860 Mhz-900 MHz, which is optimal at an operating frequency of 885 MHz, and the optimal reading distance thereof is 2 m.

The flexible UHF RFID anti-metal tag 102 used in the present embodiment uses a relatively common material, and the cost is reduced by 20% to 30% compared with the existing examples. Secondly, the tag adopts a simple composition of the same structure, and the manufacturing process is simpler and faster than the existing examples while requiring less devices. This is beneficial to the promotion for product and mass production.

The present disclosure provides a flexible UHF RFID anti-metal tag 102, which is bonded to the metal member by a self-adhesive, and does not use a special material to shield influence from the metal, but adopts an antenna layer-substrate layer-metal base layer to form a microstrip antenna structure while the metal member acting as an extension of the metal base layer, to eliminate interference of the metal on an equivalent circuit of the antenna, so that information of the flexible UHF RFID anti-metal tag may be read and written normally. The substrate layer uses a polymer material as the first dielectric layer, and a supportive flexible material of lower cost, such as a foam dielectric layer, is used as the second dielectric layer, so as to save cost while ensuring sufficient flexibility of the substrate layer, thereby greatly saving money. The flexible UHF RFID anti-metal tag 102 has the advantages of simple structure, universal material selection, low cost, and is applicable to metal plates, various surface parts of curved surfaces and round pipe products with no affection by metal materials and a wide applicability for production.

The flexible UHF RFID anti-metal tag 102 has the advantages of simple structure, universal material selection, low cost, and is applicable to metal plates, various surface parts of curved surfaces and round pipe products with no affection by metal materials and a wide applicability for production.

Finally, the method of the present disclosure is only a preferred embodiment and is not intended to limit the scope of the present disclosure. Any modifications, equivalent substitutions, improvements, and the like within the spirit and principles of the invention are intended to be included within the scope of the present disclosure.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above disclosed and other features and functions, or alternatives thereof, may be combined into other systems, methods, or applications. Various presently unforeseen or unanticipated alternatives, modifications, variations, or improvements therein may subsequently be made by those skilled in the art without departing from the scope of the present disclosure as encompassed by the following claims.

What is claimed is:

1. A flexible ultra high frequency (UHF) radio frequency identification (RFID) anti-metal tag comprising:
a tag chip, an antenna layer, a substrate layer and a metal base layer sequentially attached from top to bottom, wherein the substrate layer includes a first dielectric layer and a second dielectric layer being sequentially attached from top to bottom, further wherein the first dielectric layer being attached to the antenna layer, further wherein the second dielectric layer being attached to the metal base layer.

2. The flexible UHF RFID anti-metal tag according to claim 1 further comprising a protective layer that wraps the tag chip, wherein the protective layer being coated on the antenna layer.

3. The flexible UHF RFID anti-metal tag according to claim 2, wherein a material of the protective layer comprises an ink.

4. The flexible UHF RFID anti-metal tag according to claim 1, wherein the tag chip and the antenna layer are fixed by using at least one of a wire bonding process and a conductive adhesive.

5. The flexible UHF RFID anti-metal tag according to claim 4, wherein a wire used in the wire bonding process comprises a gold wire or an aluminum wire.

6. The flexible UHF RFID anti-metal tag according to claim 4, wherein the conductive adhesive comprises a thermosetting conductive adhesive.

7. The flexible UHF RFID anti-metal tag according to claim 1, wherein a material of the antenna layer comprises at least one of a copper or aluminum.

8. The flexible UHF RFID anti-metal tag according to claim 7, wherein the antenna is composited on the first dielectric layer by an etching process, further wherein a thickness of the antenna layer is in a range of 10-16^{μm}.

9. The flexible UHF RFID anti-metal tag according to claim 1, wherein:
the first dielectric layer comprises a polymer film, wherein a material of the polymer film comprises at least one of a polyimide or polyethylene terephthalate;
the second dielectric layer comprises a foam dielectric layer; and
the first dielectric layer and the second dielectric layer are bonded by a backing adhesive.

10. The flexible UHF RFID anti-metal tag according to claim 9, wherein a thickness of the first dielectric layer is in a range of 50-125^{82 m}, further wherein a thickness of the second dielectric layer is in a range of 2-3 mm.

11. The flexible UHF RFID anti-metal tag according to claim 1, wherein a material of the metal base layer comprises copper, further wherein the metal base layer has a same outer contour as the antenna layer.

12. The flexible UHF RFID anti-metal tag according to claim 1, wherein the flexible UHF RFID anti-metal tag is bonded to a metal member by a self-adhesive.

13. A design and verification method for flexible ultra high frequency (UHF) RFID anti-metal tag, comprising:
optimizing and determining a material and an optimal parameter of the flexible UHF RFID anti-metal tag by using an electromagnetic simulation software comprising at least one of a high frequency structure simulator (HFSS) or a computer simulation technology (CST), and fabricating the flexible UHF RFID anti-metal tag; and
connecting a Tagformance reader to the flexible UHF RFID anti-metal tag and collecting a performance parameter of the flexible UHF RFID anti-metal tag until the flexible UHF RFID anti-metal tag reaches an optimal reading distance, and reading an information.
